(19) United States
(12) Patent Application Publication
(10) Pub. No.: US 2024/0239429 A1
(43) Pub. Date: Jul. 18, 2024

(54) Elastic-Bound Glowing Cover for Motorcycles

(71) Applicant: Richard Crow, JR., Duncan, SC (US)

(72) Inventor: Richard Crow, JR., Duncan, SC (US)

(21) Appl. No.: 18/411,776

(22) Filed: Jan. 12, 2024

Related U.S. Application Data
(60) Provisional application No. 63/438,600, filed on Jan. 12, 2023.

(51) Int. Cl. B62J 6/20; B32B 5/02; B32B 5/26; B62J 23/00; G02B 5/12

(52) U.S. Cl. CPC B62J 6/20; B32B 5/028; B32B 5/26; B62J 23/00; G02B 5/12; B32B 2262/0261; B32B 2262/0276; B32B 2262/062; B32B 2307/416; B32B 2307/422; B32B 2307/5825; B32B 2307/7265; B32B 2605/00

(57) ABSTRACT

A glow cover for parts of a motorcycle. The glow cover includes a reflective bottom layer and an attached glow-in-the-dark top layer. The cover is secured to the motorcycle using an elastic circumferential boundary that provides a snug fit and helps to keep the cover securely in place during use and while the motorcycle is at speed on the roadway. The elastic material conforms to the shape of the motorcycle, creating a secure fit that helps to keep the cover in place during use.

The cover includes different portions for covering various parts of the motorcycle such as the front fender, fuel tank, airbox, saddlebag, headlight, and more. The cover is designed to glow in the dark, enabling other motorists to see the motorcycle and driver from long distances thus reducing the chance of an accident occurring with other motorists who may have trouble seeing a motorcycle.

### CROSS-REFERENCE TO RELATED APPLICATION

The present application claims priority to, and the benefit of, U.S. Provisional Application No. 63/438,600, which was filed on Jan. 12, 2023, and is incorporated herein by reference in its entirety.

### FIELD OF THE INVENTION

The present invention generally relates to the field of motorcycle covers. More specifically, the present invention relates to a novel glowing cover for motorcycles designed to cover different parts of a motorcycle and to glow in low light and at night for improving security and visibility of motorcycle and rider. The cover glows to ensure the cycle and its passenger are visible and reduces the chance of an accident occurring with other motorists who may have trouble seeing a motorcycle driver. Accordingly, the present disclosure makes specific reference thereto. Nonetheless, it is to be appreciated that aspects of the present invention are also equally applicable to other like applications, devices, and methods of manufacture.

### BACKGROUND

By way of background, motorcycles are smaller than the majority of other vehicles such as cars, trucks, and buses on the road. This prevents other drivers from being able to see the motorcycles, especially at night and in other low-light situations. This makes it more challenging for other motorists to spot motorbikes on the road, increasing the possibility of accidents and collisions. Due to the small stature of motorcycles, motorbikes may also be overlooked by pedestrians, which can result in dangerous circumstances. Further, motorcycles are generally dark in color which makes it difficult to spot them.

Therefore, motorcyclists are more vulnerable on the road than drivers of other vehicles. Further, motorcycles do not have the protection of steel frames, airbags, and other safety features that cars and trucks provide. Accidents involving motorcycles can be particularly dangerous and may result in severe injuries or even fatalities. Inattentional blindness is a phenomenon where drivers fail to see objects or vehicles that are in their field of vision due to distractions or other factors. This can be particularly dangerous for motorcycles, as other drivers may fail to see motorcycles on the road, even if they are wearing bright, noticeable clothing. While some motorcyclists may wear clothing that is noticeable in low light and at night, this may not always be possible or effective. Motorcycle drivers desire a device that can be particularly useful in improving motorcycle visibility and reducing the risk of accidents.

Therefore, there exists a long felt need in the art for a glowing device for motorcycles that helps improve visibility of the vehicle while on the road. There is also a long felt need in the art for a glowing device that can be used with a motorcycle during travelling for improving visibility of the motorcycle. Additionally, there is a long felt need in the art for a glowing motorcycle cover that glows during lowlight and nighttime conditions. Moreover, there is a long felt need in the art for a glowing motorcycle cover that does not impact movement of the motorcycle while riding the motorcycle. Further, there is a long felt need in the art of a glowing cover that improves security of a motorcycle driver by improving visibility of the motorcycle. Furthermore, there is a long felt need in the art for a glowing cover that makes riding safer and more enjoyable for motorcyclists. Finally, there is a long felt need in the art for a glowing cover for motorcycles that reduces the chance of an accident occurring with other motorists who may have trouble seeing a motorcycle.

The subject matter disclosed and claimed herein, in one embodiment thereof, comprises a glow cover for motorcycles. The glow cover includes two layers including a bottom layer constructed with a weatherproof and tear-resistant material, the bottom layer having a reflective exterior surface and a cotton-lined interior surface, and an elastic circumferential boundary along the length thereof for securing to different parts of a motorcycle, a top layer made of an elastic glow-in-the-dark netting material and sewn along the elastic circumferential boundary of the bottom layer, wherein the bottom layer and top layer are designed and dimensioned to cover different parts of the motorcycle for improving the visibility of the motorcycle during any type of low-light conditions. The reflective exterior surface of the bottom layer has a retroreflective material configured to reflect light back to its source, making the motorcycle more visible to other drivers on the road. The glow cover is designed to cover at least a front fender, a fuel tank, a headlight, an airbox and a saddle box.

In this manner, the glow cover for motorcycles of the present invention accomplishes all of the forgoing objectives and provides users with a glowing cover for a motorcycle designed to help improve visibility of the motorcycle while on the road. The cover is wrapped on multiple areas of the motorcycle and does not impact movement of the motorcycle during riding. The cover glows during lowlight and during nighttime conditions to ensure the cycle and its passenger are visible and safe.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorcycle glow cover. The motorcycle glow cover is multi-layered and further comprising a planar and flexible bottom layer constructed with a weatherproof and tear-resistant material, the bottom layer having a reflective exterior surface and a cotton-lined interior surface, and an elastic circumferential boundary for securing to different parts of a motorcycle, a top layer made of an elastic glow-in-the-dark netting material and sewn along the elastic circumferential boundary of the bottom layer, wherein the bottom layer and top layer are designed and dimensioned to cover different parts of the motorcycle for improving the visibility of the motorcycle during any type of low-light conditions. The reflective exterior surface of the bottom layer has a retroreflective material configured to reflect light back to its source, making the motorcycle more visible to other drivers on the road.

In yet another embodiment, a motorcycle glow cover is disclosed. The motorcycle glow cover comprising a bottom layer and an integrally attached top layer made of an elastic glow-in-the-dark netting material that absorbs light during the daytime and glows in the dark during low-light conditions, wherein the bottom layer has an elastic circumferential boundary for stable and secure installation on different parts of a motorcycle, and the exterior surface of the bottom layer is reflective and enhances the visibility of the motorcycle during low-light conditions, such as at dawn or dusk, or during inclement weather, wherein the reflective material used on the exterior surface of the bottom layer is a retroreflective material configured to reflect light back to its source, making the motorcycle more visible to other drivers on the road.

In a further embodiment, the interior surface of the bottom layer has a cotton lining for providing support and stability to the bottom layer while adhering to the motorcycle.

In yet another embodiment, the motorcycle glow cover is removably placed on the motorcycle without using any tool or without requiring professional help.

In a further embodiment, a method for improving visibility of a motorcycle at night and in low-light areas is described. The method comprising the steps of providing a glow cover, the glow cover is a multi-layered cover for covering different portions of the motorcycle, the glow cover having a reflective bottom layer and a top elastic glow-in-dark net layer, stretching an elastic boundary of the bottom layer over various parts of the motorcycle, the elastic boundary comprising an elastic material that conforms to the shape of the motorcycle, snapping the elastic boundary into place to snugly fit the glow cover along the edges of the various parts of the motorcycle, creating a secure fit that keeps the cover in place during use and enabling the cover to snugly fit along different portions of the motorcycle, thereby covering the motorcycle and enabling other motorists to see the motorcycle and driver from long distances.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a glowing cover of the present invention for a motorcycle in accordance with the disclosed architecture;

FIG. 2 illustrates a perspective view of the motorcycle glow cover of FIG. 1 placed on a motorcycle in accordance with the disclosed architecture;

FIG. 3 illustrates an enlarged view showing how the glow cover of the present invention is secured to the motorcycle in accordance with the disclosed architecture;

FIG. 4 illustrates an enlarged view showing the integration of the bottom layer and the top layer in accordance with the disclosed architecture; and

FIG. 5 illustrates a flow diagram depicting a process of using the elastic-bound glowing cover of the present invention by a motorist for improving roadway safety in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a glowing device for motorcycles that helps improve visibility of the vehicle while on the road. There is also a long felt need in the art for a glowing device that can be used with a motorcycle during travelling for improving visibility of the motorcycle. Additionally, there is a long felt need in the art for a glowing motorcycle cover that glows during lowlight and nighttime conditions. Moreover, there is a long felt need in the art for a glowing motorcycle cover that does not impact movement of the motorcycle while riding the motorcycle. Further, there is a long felt need in the art of a glowing cover that improves security of a motorcycle driver by improving visibility of the motorcycle.

Furthermore, there is a long felt need in the art for a glowing cover that makes riding safer and more enjoyable for motorcyclists. Finally, there is a long felt need in the art for a glowing cover for motorcycles that reduces the chance of an accident occurring with other motorists who may have trouble seeing a motorcycle.

The present invention, in one exemplary embodiment, is a method for improving visibility of a motorcycle at night and in low-light areas. The method comprising the steps of providing a glow cover for motorcycle, the glow cover designed for covering different portions of the motorcycle, the glow cover having a reflective bottom layer and a top elastic glow-in-dark net layer, stretching an elastic boundary of the bottom layer over various parts of the motorcycle, the elastic boundary comprising an elastic material that conforms to the shape of the motorcycle, snapping the elastic boundary into place to snugly fit the glow cover along the edges of the various parts of the motorcycle, creating a secure fit that keeps the cover in place during use and enabling the cover to snugly fit along different portions of the motorcycle, thereby covering the motorcycle and enabling other motorists to see the motorcycle and driver from long distances.

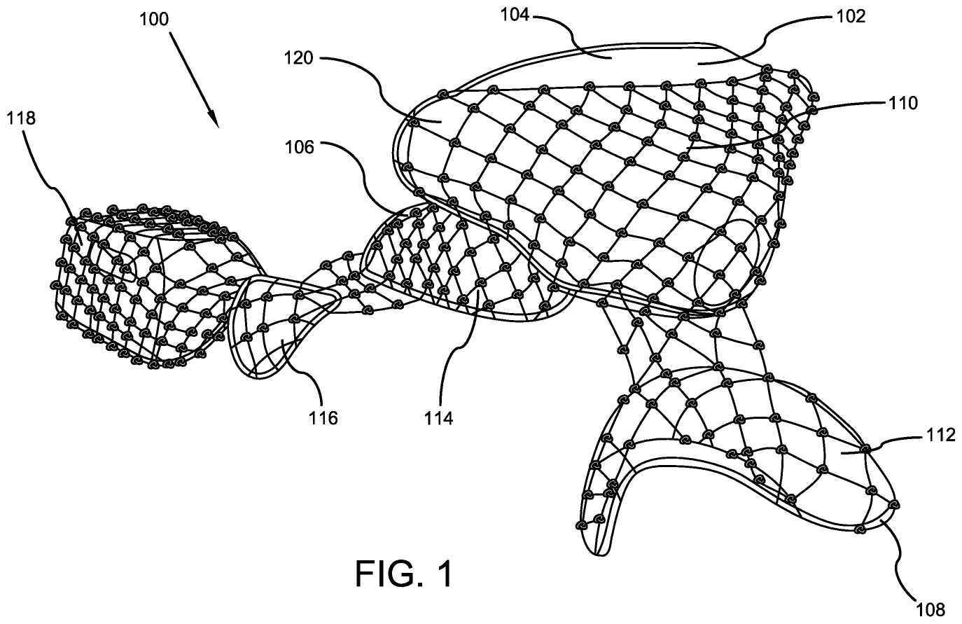

Referring initially to the drawings, FIG. 1 illustrates a perspective view of one potential embodiment of a glowing cover of the present invention for a motorcycle in accordance with the disclosed architecture. The glow cover 100 of the present invention is designed to be placed over a motorcycle for improving visibility of the motorcycle during any type of lowlight conditions. More specifically, the glowing cover 100 is designed and dimensioned to cover different designs of motorcycles of different manufacturers. The glowing cover 100 has a planar and flexible bottom layer 102 constructed with a weatherproof and tear resistant material such as 210D polyester fabrics, 300 denier polyester, nylon, and the like. The flexible bottom layer 102 is designed to cover different parts of a motorcycle for protecting the motorcycle from dust, dirt, and debris.

Exterior surface 104 of the bottom layer 102 is reflective and enhances the visibility of the motorcycle during low-light conditions, such as at dawn or dusk, or during inclement weather. The reflective surface 104 helps other motorists to see the cover (and the motorcycle on which the cover 100 is placed) from a distance, making it easier to avoid collisions. The reflective material used on the exterior surface 104 of the bottom layer 102 of the motorcycle cover 100 is preferably made of retroreflective material configured to reflect light back to its source, making the motorcycle more visible to other drivers on the road. The retroreflective material may include one of glass beads technology, microprismatic technology, or polymer-based technology. It should be noted that the choice of reflective material for the exterior surface 104 of the bottom layer 102 can depend on factors such as durability, effectiveness, and cost.

The interior surface 106 of the bottom layer 102 has cotton lining for providing support and stability to the bottom layer 102 when the cover 100 is placed on a motorcycle. The bottom layer 102 is configured to adhere to different parts of a motorcycle and has an elastic circumferential periphery 108. The elastic circumferential boundary 108 enables the bottom layer 102 to conform and adhere to different parts of a motorcycle for stable and secure installation. Preferably, the elastic circumferential boundary 108 is in the form of elastic hem or band that runs around the terminal perimeter of the bottom layer 102.

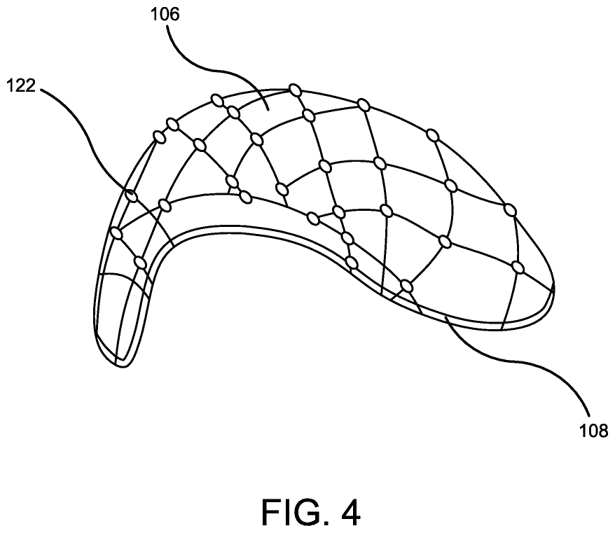

The top layer 110 of the glow in the dark cover 100 is an elastic net-type layer and is integrally attached to the bottom layer 102. The top layer 110 is preferably sewn along the elastic circumferential periphery 108 such that the top layer 110 does not blow away during riding of the motorcycle as illustrated in FIG. 4. The top layer 110 is made up of an elastic glow-in-the-dark netting material which is designed to absorb light during the daytime and then glow in the dark during low-light conditions. The top layer 110 provides an additional layer of visibility for the motorcycle, making it more visible to other motorists on the road. The top layer 110 can glow in any conventional color as per preferences of users such as neon, yellow, white, and more.

The motorcycle glow cover 100 is designed to cover different parts of a motorcycle such that the motorcycle is visible from long distances in low-light and at night. As illustrated, the cover 100 has a front fender cover portion 112 for covering a front fender of a motorcycle, a fuel tank cover portion 114 for covering a fuel tank of the motorcycle, an airbox cover portion 116 for covering an airbox of the motorcycle, a saddle bag cover portion 118 for covering a saddle bag of the motorcycle, and a front cover portion 120 for covering a headlight of the motorcycle. In some embodiments of the present invention, the motorcycle glow cover 100 can have any other portions for covering other parts of the motorcycle.

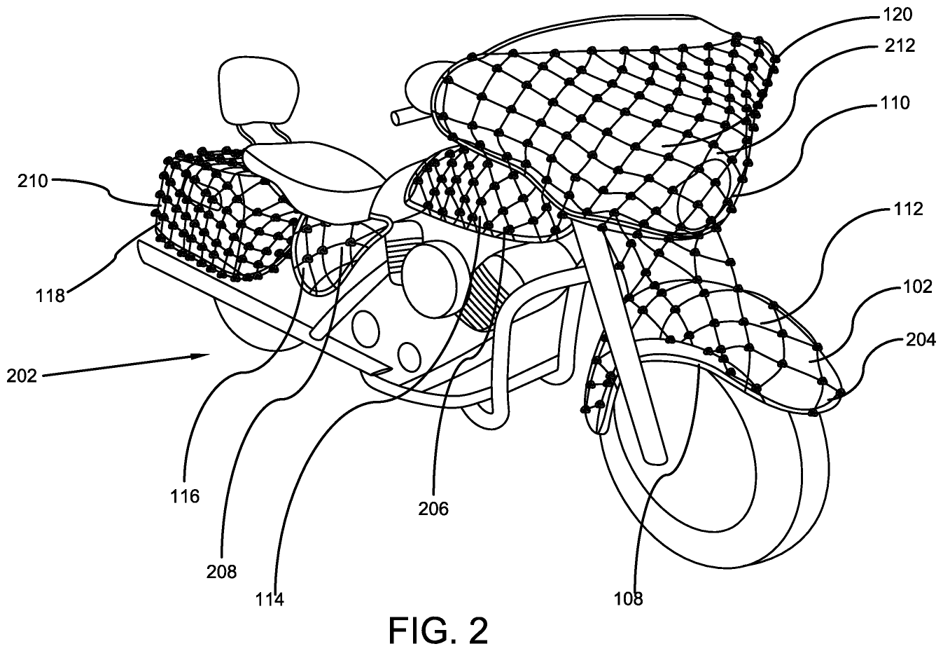

FIG. 2 illustrates a perspective view of the motorcycle glow cover of FIG. 1 placed on a motorcycle in accordance with the disclosed architecture. The motorcycle glow cover 100 can be removably placed on the motorcycle 202 without using any tool or without requiring professional help. The bottom layer 102 and the attached top layer 110 of the motorcycle glow cover 100 is installed using the elastic circumferential boundary 108. The elastic boundary 108 provides a snug fit and helps to keep the cover 100 securely in place during use. The elastic material conforms to the shape of the motorcycle 202, creating a secure fit that helps to keep the cover 100 in place during use.

As illustrated, the front fender cover portion 112 covers the front fender 204 of the motorcycle 202, the fuel tank cover portion 114 covers the fuel tank 206 of the motorcycle 202, the airbox cover portion 116 covers the airbox 208 of the motorcycle 202, the saddle bag cover portion 118 covers the saddle bag 210 of the motorcycle and the front cover portion 120 covers the front portion 212 of the motorcycle 202. Based on the design of the motorcycle 202, the cover 100 can have additional portions for covering different parts of the motorcycle 202.

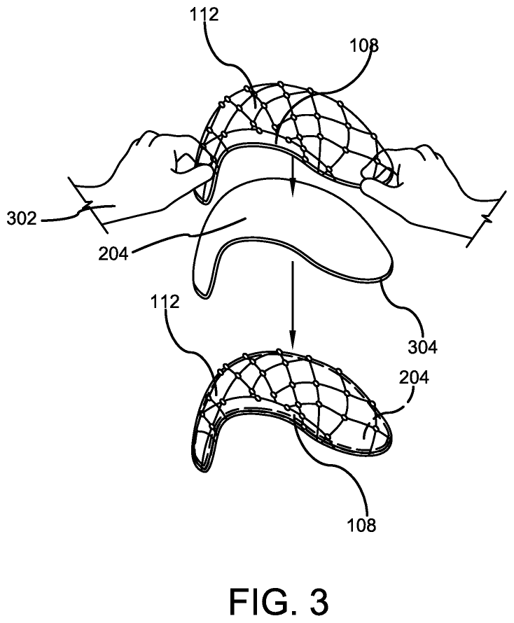

FIG. 3 illustrates an enlarged view showing how the glow cover of the present invention is secured to the motorcycle in accordance with the disclosed architecture. To secure the elastic-bound glow motorcycle cover 100 to the motorcycle 202, the elastic boundary 108 is stretched over the various parts of the motorcycle 202 and is allowed to snap into place. As illustrated, a user 302 stretches the elastic boundary 108 of the front fender cover portion 112 to snugly fit the front fender cover portion 112 along edge 304 of the front fender 204. The elastic material of the elastic boundary 108 conforms to the shape of the motorcycle, creating a secure fit that helps to keep the cover 100 in place during use. It is to be appreciated that ‘during use’ refers to the cover 100 elastically secured and retained around the separate parts of the motorcycle while the motorcycle is ridden over the road, street, or highway at speed. The cover 100 snugly fits along different portions of the motorcycle 202 to cover the motorcycle 202 and enabling other motorists to see the motorcycle 202 and driver from long distances.

FIG. 4 illustrates an enlarged view showing the integration of the bottom layer 102 and the top layer 110 in accordance with the disclosed architecture. The boundary 122 of the top layer 110 is sewn along the elastic boundary 108 of the bottom layer 102 on the interior surface 106 for securing the top layer 110 to the bottom layer 102. The top layer 110 adheres to the exterior surface 104 of the bottom layer 102 enabling other motorists to see the motorcycle and rider from long distances.

In other embodiments of the present invention, a variety of other securing mechanisms such as hook and loop fasteners, snap fasteners, and more can be used for securing the top layer 110 to the bottom layer 102. It is possible that the top layer 110 is designed to rest on top of the bottom layer 102, without any additional securing mechanism.

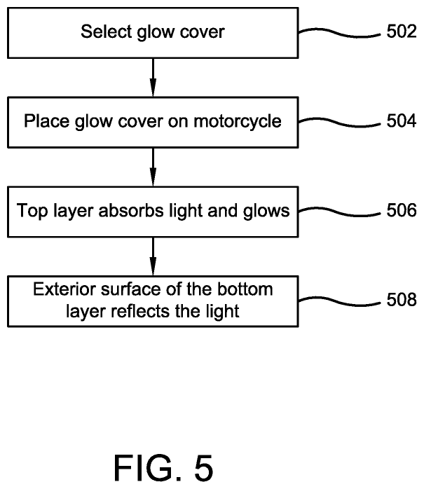

FIG. 5 illustrates a flow diagram depicting a process of using the elastic-bound glowing cover of the present invention by a motorist for improving roadway safety in accordance with the disclosed architecture. Initially, a glow cover of appropriate size and design is selected by a motorist based on design and manufacturing of the motorcycle (Step 502). Then, the cover 100 is positioned on different parts of the motorcycle by securing the elastic boundary as described in FIG. 3 (Step 504). It should be noted that the cover 100 does not cover or mounted on any of the brakes, electronic components, and display of the motorcycle, therefore, does not obstruct use of the motorcycle.

Then, the top layer 110 absorbs light during the day and then glows during the night or low-light (Step 506). Also, the exterior surface of the bottom layer 102 reflects the light incident thereon for providing illumination and enabling other motorists to easily see the motorcycle and rider from long distances (Step 508).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “motorcycle glow cover”, “glow cover”, “glowing cover”, “elastic-bound glowing cover”, and “cover” are interchangeable and refer to the elastic-bound glowing cover for motorcycles 100 of the present invention.

Notwithstanding the forgoing, the elastic-bound glowing cover for motorcycles 100 of the present invention can be of any suitable size and configuration as is known in the art without affecting the overall concept of the invention, provided that it accomplishes the above stated objectives. One of ordinary skill in the art will appreciate that the elastic-bound glowing cover for motorcycles 100 as shown in the FIGS. are for illustrative purposes only, and that many other sizes and shapes of the elastic-bound glowing cover for motorcycles 100 are well within the scope of the present disclosure. Although the dimensions of the elastic-bound glowing cover for motorcycles 100 are important design parameters for user convenience, the elastic-bound glowing cover for motorcycles 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A glowing cover for parts of motorcycles, the glowing cover comprising:
a flexible bottom layer including a weatherproof and tear resistant material and a flexible top layer;
wherein said glowing cover fitted to cover different parts of the motorcycle;
wherein said flexible bottom layer having a shape to cover separate parts of a motorcycle for protecting the motorcycle from dust, dirt, and debris;
wherein said flexible bottom layer having an exterior surface including a reflective portion for enhancing the visibility of the motorcycle during low-light conditions;
wherein said reflective portion having a material used on said exterior surface including retroreflective material to reflect light back to its source; and
further wherein said retroreflective material selected from a group consisting of a glass beads material, a micro prismatic material, and a polymer material.

2. The glowing cover for parts of motorcycles of claim 1, wherein said flexible bottom layer having a cotton lining for providing support and stability to said flexible bottom layer when said glowing cover placed on said separate parts of the motorcycle.

3. The glowing cover for parts of motorcycles of claim 2, wherein said flexible bottom layer having an elastic circumferential periphery to adhere to said separate parts of the motorcycle during use of the motorcycle at speed.

4. The glowing cover for parts of motorcycles of claim 3, wherein said elastic circumferential periphery secures said flexible bottom layer to said separate parts of the motorcycle during use of the motorcycle at speed.

5. The glowing cover for parts of motorcycles of claim 4, wherein said elastic circumferential periphery having an elastic band extending around a terminal perimeter of said flexible bottom layer.

6. The glowing cover for parts of motorcycles of claim 5, wherein said flexible top layer having an elastic glow-in-the-dark net layer circumscribing said flexible bottom layer, and further wherein said elastic glow-in-the-dark net layer absorbs light during the daytime and glows during the nighttime.

7. The glowing cover for parts of motorcycles of claim 6, wherein said flexible bottom layer having a material selected from a group consisting of a 210D polyester fabric, a 300 denier polyester, and a nylon.

8. The glowing cover for parts of motorcycles of claim 7, wherein said separate parts of the motorcycle include parts selected from a group consisting of a front fender cover portion, a fuel tank cover portion, an airbox cover portion, a saddle bag cover portion, and a front cover portion.

9. The glowing cover for parts of motorcycles of claim 8, wherein said elastic band and said elastic glow-in-the-dark net layer securing said glowing cover around said separate parts of the motorcycle during use of the motorcycle at speed.

10. A glowing cover for parts of motorcycles, the glowing cover comprising:
a flexible bottom layer including a weatherproof and tear resistant material and a flexible top layer;
wherein said glowing cover fitted to cover different parts of the motorcycle;
wherein said flexible bottom layer having a shape to cover separate parts of a motorcycle for protecting the motorcycle from dust, dirt, and debris;
wherein said flexible bottom layer having an exterior surface including a reflective portion for enhancing the visibility of the motorcycle during low-light conditions;
wherein said reflective portion having a material used on said exterior surface including retroreflective material to reflect light back to its source;
wherein said retroreflective material selected from a group consisting of a glass beads material, a micro prismatic material, and a polymer material;
wherein said flexible top layer having an elastic glow-in-the-dark net layer circumscribing said flexible bottom layer for securing said glowing cover during use of the motorcycle at speed; and
further wherein said elastic glow-in-the-dark net layer absorbs light during the daytime and glows during the nighttime.

11. The glowing cover for parts of motorcycles of claim 10, wherein said flexible bottom layer having a cotton lining for providing support and stability to said flexible bottom layer when said glowing cover placed on said separate parts of the motorcycle.

12. The glowing cover for parts of motorcycles of claim 11, wherein said flexible bottom layer having an elastic circumferential periphery to adhere to said separate parts of the motorcycle.

13. The glowing cover for parts of motorcycles of claim 12, wherein said elastic circumferential periphery secures said flexible bottom layer to said separate parts of the motorcycle.

14. The glowing cover for parts of motorcycles of claim 13, wherein said elastic circumferential periphery having an elastic band extending around a terminal perimeter of said flexible bottom layer.

15. The glowing cover for parts of motorcycles of claim 14, wherein said flexible bottom layer having a material selected from a group consisting of a 210D polyester fabric, a 300 denier polyester, and a nylon.

16. The glowing cover for parts of motorcycles of claim 15, wherein said separate parts of the motorcycle include parts selected from a group consisting of a front fender cover portion, a fuel tank cover portion, an airbox cover portion, a saddle bag cover portion, and a front cover portion.

17. The glowing cover for parts of motorcycles of claim 16, wherein said elastic band and said elastic glow-in-the-dark net layer securing said glowing cover around said separate parts of the motorcycle during use of the motorcycle at speed.

18. A glowing cover for parts of motorcycles, the glowing cover comprising:
a flexible bottom layer including a weatherproof and tear resistant material and a flexible top layer;
wherein said glowing cover fitted to cover different parts of the motorcycle;
wherein said flexible bottom layer having a shape to cover separate parts of a motorcycle for protecting the motorcycle from dust, dirt, and debris;
wherein said flexible bottom layer having an exterior surface including a reflective portion for enhancing the visibility of the motorcycle during low-light conditions;
wherein said reflective portion having a material used on said exterior surface including retroreflective material to reflect light back to its source;
wherein said flexible bottom layer having an elastic circumferential periphery to adhere to said separate parts of the motorcycle during use of the motorcycle at speed;
wherein said flexible top layer having an elastic glow-in-the-dark net layer circumscribing said flexible bottom layer for retaining said glowing cover during use of the motorcycle at speed;
wherein said elastic glow-in-the-dark net layer absorbs light during the daytime and glows during the nighttime; and
further wherein said elastic glow-in-the-dark net layer having a boundary sewn along said elastic circumferential periphery of said flexible bottom layer for securing said flexible top layer to said flexible bottom layer.

19. The glowing cover for parts of motorcycles of claim 18, wherein said retroreflective material selected from a group consisting of a glass beads material, a micro prismatic material, and a polymer material.

20. The glowing cover for parts of motorcycles of claim 19, wherein said elastic circumferential periphery having an elastic band extending around a terminal perimeter of said flexible bottom layer.
